(19) United States
(12) Patent Application Publication
(10) Pub. No.: US 2021/0127697 A1
(43) Pub. Date: May 6, 2021

(54) METHOD FOR PRODUCING CHEESE

(71) Applicant: FrieslandCampina Nederland B.V., Amersfoort (NL)

(72) Inventors: Fransiscus Christophorus GIELENS, Wageningen (NL); Wilhelmus Hendrikus Johannes TAP, Wageningen (NL)

(21) Appl. No.: 17/146,315

(22) Filed: Jan. 11, 2021

Related U.S. Application Data
(63) Continuation of application No. PCT/EP2019/068810, filed on Jul. 12, 2019.

(30) Foreign Application Priority Data
Jul. 13, 2018 (EP) 18183299.9

(51) Int. Cl. A23C 19/05; A23L 29/281; A23L 33/19

(52) U.S. Cl. CPC A23C 19/05; A23L 33/19; A23L 29/281

(57) ABSTRACT

The invention relates to methods for making cheese, in particular to improving the productivity of the cheese making process by controlling the rate of coagulation of a cheese milk and/or the strength of the gel network formed. Provided is a method for providing a cheese curd, comprising the steps of (i) providing a starting cheese milk that has an increased micellar casein content as compared to natural bovine milk; (ii) adding non-micellar casein protein to the cheese milk to obtain a casein-supplemented cheese milk; (iii) subjecting the casein-supplemented cheese milk to a coagulation process to form a gel; and (iv) cutting the gel into a cheese curd.

### CROSS-REFERENCE TO RELATED APPLICATIONS

This application is a continuation of International Application No.PCT/EP2019/068810 filed Jul. 12, 2019 which claims the benefit of and priority to European Application No. 18183299.9, filed Jul. 13, 2018, both of which are hereby incorporated by reference herein in their entireties.

### FIELD OF THE INVENTION

The invention relates to methods for making cheese. More particularly, it relates to improving the productivity of the cheese making process by controlling the rate of coagulation of a cheese milk and/or the strength of the gel network formed.

### BACKGROUND TO THE INVENTION

The first major step in the cheese making process is the coagulation of the milk by enzymatic hydrolysis of κ-casein. To achieve this end, enzyme extracts (rennet) from calf stomach, microbially produced enzymes or other enzymes are utilized. Casein Macro Peptide (CMP) is cleaved from the casein protein as a result of the action of the rennet on κ-casein and about 90% of this CMP is typically removed with the whey. The hydrolysis of κ-casein leads to destabilization of the colloidal system of the milk. This is followed by aggregation of the casein micelles into clusters. Over time, the clusters grow in size. This growth in size is followed by crosslinking between chains which eventually transforms the milk into a gel or coagulum.

Once a desired point is reached in the coagulation process, the coagulum is “cut” by traversing with wire knives to slice the coagulum into pieces. The coagulating matrix then shrinks during further processing and as a result forces liquid from the cubes. Consequently, a two phase system of curd and whey results. The textural strength or firmness of the curd increases with time.

Selection of the optimum point to cut the coagulum has been a subject of much research. It has been shown that coagulum strength at cutting effects the recovery of milk components during cheese making. For example, milk components not entrapped in the κ-casein matrix are lost into the whey. Thus, cutting the coagulum when it is extremely soft decreases the cheese yield due to the increased loss of fat and curd fines. Conversely, cutting when the coagulum is too firm retards syneresis and results in a high moisture cheese. There is also a mechanical issue: as the rate of increase of firmness increases the process will be so fast that there is no practical timeslot in which to cut the curd. Moreover, the curd will be so firm that the force required for cutting cannot be delivered by the cutting tools.

Curd firmness and the rate of firming are affected by many factors. For example, a high κ-casein concentration increases curd firmness. The time and temperature of milk storage prior to cheese manufacture also affects curd firmness. Homogenization and standardization may also influence coagulum firmness.

The cheese making industry is constantly seeking for improvements of the traditional cheese manufacturing process in order to make the process more efficient, to obtain a higher yield, and/or to reduce or even eliminate recycle streams of fat and protein.

Microfiltration (MF) is an energy saving membrane process that received recently an increasing interest in dairy processing, including the use of MF retentate in the manufacture of different cheeses. Due to its wide range of pore sizes (0.1-12 μm), MF can be used to separate several components from milk and other dairy fluids. Small pore size (˜0.1 μm) MF has been used for partial removal of whey proteins from milk. This operation makes it possible, in one single operation, to separate milk into a retentate enriched specifically in native casein micelles (size ˜100-150 nanometers), and a permeate containing native soluble proteins (size 2-10 nanometers). The content of the retentate is similar to that of the treated milk, but with an increased content in native micellar casein, and consequently a higher content in dry matter, total nitrogen matter and colloidal calcium. Use of the retentate for the casein enrichment of cheese milk to increase the dry matter content has attracted significant attention of many cheese manufacturing plants to improve the cheese yield and to reduce the production costs of numerous cheese varieties. See for example WO2009/059266.

However, it is also observed that an increased content of micellar casein in cheese milk enhances the rate of coagulation and results in an increased gel strength. This makes it very difficult, especially in an industrial setting, to determine when the desired point in the coagulation process is reached. As a consequence, a major loss of fat and protein to the whey fraction can occur which results in a lower overall yield. A further drawback of the shortened clotting time and/or firmer gel relates to technical/mechanical difficulties during processing and/or cutting using conventional curd manufacturing equipment.

### SUMMARY OF THE INVENTION

The present inventors sought to address at least one of these drawbacks of using casein-enriched cheese milks. It was surprisingly observed that the addition of only a small amount of non-micellar casein, such as caseinate or CMP, reduces the rate of gel formation of casein-enriched milk. The increased coagulation time upon addition of non-micellar casein creates an opportunity to substantially increase the casein content in the cheese milk, while avoiding premature or uncontrolled gelation. This contributes to maximizing productivity and reducing losses. Herewith, the invention provides not only allows for a consistent process using conventional curding equipment, but also for an enhanced overall yield and efficiency of cheese making at an industrial scale.

### DETAILED DESCRIPTION

Accordingly, in one embodiment the invention provides a method for providing a cheese curd, comprising the steps of

(i) providing a starting cheese milk that has an increased micellar casein content as compared to natural bovine milk;

(ii) adding non-micellar casein protein to the cheese milk to obtain a casein-supplemented cheese milk;

(iii) subjecting the casein-supplemented cheese milk to a coagulation process to form a gel; and

(iv) cutting the gel into a cheese curd.

In another embodiment, the invention provides a method for increasing the yield of a cheese making process wherein the above process for preparing a cheese curd is applied followed by separating the whey from the curd and processing the curd into a cheese. Accordingly, in this embodiment the method for increasing the yield of a cheese making process comprises the steps of

(i) providing a starting cheese milk that has an increased micellar casein content as compared to natural bovine milk;

(ii) adding non-micellar casein protein to the cheese milk to obtain a casein-supplemented cheese milk;

(iii) subjecting the casein-supplemented cheese milk to a coagulation process to form a gel;

(iv) cutting the gel into a cheese curd and separating the whey from the curd; and

(v) processing the curd into a cheese.

Methods and factors that influence the coagulation process during cheese making are known in the art.

WO2006/067186 relates to the use of high heated milk for cheese making and the technical problems associated therewith. In particular, it discloses that the addition of a protein hydrolysate, a peptide or peptide mixture to heated milk results in reduction or elimination of the increased clotting time and increased curd weakness that would normally be encountered when high heated milk is used. Hydrolyzed whey protein is preferred. Hence, in contrast to the present invention, WO2006/067186 is aimed at speeding up the coagulation process and obtaining a stronger gel network

Gamlath et al. (Food Chemistry 244 (2018) 36-43) investigated the role of native whey protein on the kinetics and mechanism of rennet gelation. It was observed that native whey protein inhibits kappa-casein hydrolysis by chymosin and that whey proteins have an inhibitory role during rennet gelation of milk.

WO02/30210 discloses a dairy product that contains dairy proteins, the product being at least semi-solid and containing greater than 0.15% by weight of casein macropeptide (CMP). The mass ratio of CMP to whey protein is 1:4.9 or greater. The product may be a natural cheese or a processed cheese. To obtain the desired product, a natural casein isolate protein (NCI) source is combined with a moisture and a fat source and coagulated. WO02/30210 fails to teach a starting cheese milk that has an increased micellar casein content to which a non-micellar casein protein is added.

Hence, a method of the invention wherein non-micellar casein is added to a cheese milk to counteract unwanted effects of micellar casein is not known or suggested in the art.

Bovine milk contains 3-4 wt % protein and almost 80 wt % of the milk protein fraction consists of four caseins; αs1-casein (αs1-CN), ß-casein (ß-CN), αs2-casein (αs2-CN) and κ-casein (κ-CN), which occur at a ratio of ˜4:1:3.5:1.5, respectively. The casein content of raw, pasteurized and UHT milks is generally held to be about 25-26 g casein/l milk. Most of the caseins in milk are assembled in casein micelles, which are highly hydrated association colloids consisting of several thousands of individual casein molecules and salts.

Micellar casein, also referred to as native micellar casein, refers to casein in the form of micelles. It is a high quality milk protein and naturally occurring in milk in a concentration of about 2.6 g/100 ml. In contrast, non-micellar casein, as it is used in the context of this invention encompasses the form of casein that has lost its native micellar structure. It is bound to a metal, such as sodium, calcium and/or magnesium. According to the invention, the starting cheese milk has an increased micellar casein content as compared to that of natural bovine milk, which typically has a micellar casein content of 2.6-2.8% by weight (wt %), based on total weight of milk. In one aspect, the starting cheese milk has a micellar casein content of at least 2.7 wt %, preferably in the range of 3 to 15 wt %, more preferably in the range of 4 to 9 wt % (based on total weight of milk)

Cows' milk consists of about 87 wt % water and 13 wt % dry substance. As it comes from the cow, the solids portion of milk contains approximately 3.7 wt % fat and 9 wt % solids-not-fat. The solids-not-fat portion consists of protein (primarily casein and lactalbumin), carbohydrates (primarily lactose), and minerals (including calcium and phosphorus). The solids content of the starting cheese milk according to the present invention can be the same or higher than that of natural bovine milk. Preferably, it is higher than that of natural bovine milk. In one embodiment, the solid content is at least 3.4 wt %. For example, it has a solids content of between about 7 wt % and about 25 wt %.

A starting cheese milk for use in a method of the invention can be prepared in many different ways, using a diverse set of ingredients. In one embodiment, the starting cheese milk comprises one or more of (i) skim milk, (ii) whole milk and/or (iii) cream that is supplemented with a source of micellar casein, so as to obtain an increased micellar casein content as compared to that of natural bovine milk.

Various sources of micellar casein can be used. In one embodiment, the micellar casein is obtained by a milk concentration process. Such product is marketed as Micellar Casein Isolate (MCI). MCI powder is a protein ingredient that belongs to the group of high-protein dairy powders with protein contents higher than 80 wt %. It is also referred to in the art as native phosphocaseinate, MCI, or micellar casein. It is produced by membrane filtration of skim milk followed by spray drying. During production, whey proteins are removed and caseins are preserved in the micellar state, containing colloidal calcium phosphate. A microfiltration membrane with pore size of approximately 0.1 pm is typically chosen to allow separation of whey proteins from micellar casein (Carr and Golding 2016. In: McSweeney PLH, O′Mahony JA, editors. Advanced dairy chemistry. Vol. 1B: Proteins: applied aspects. 4th ed. Cork: Springer. p 35-66.). After microfiltration, the micellar casein may be spray-dried or used as liquid concentrate.

Micellar casein for use in the present invention may also be provided by other milk protein sources, such as, for instance, sources with essentially preserve the natural ratio of casein to whey, such as Milk Protein Concentrate (MPC), which is a powder product or liquid concentrate usually prepared by ultrafiltration with an average protein content of over 30-35 weight %, or Milk Protein Isolate (MPI), a powder product usually prepared by precipitation with an average protein content of more than 85 weight %.

MPCs are produced by heat-treating skim milk and concentrating the protein fractions, both the whey proteins and caseins, using membrane technology. Usually, MPC powder contains approximately 82 wt % casein and 18 wt % whey proteins based on the total protein content, which is the same ratio as in raw milk. Caseins are present in micellar structure and whey proteins in their native globular form or with some degree of denaturation due to the thermal treatment during processing. MPCs have been developed with different compositions and used as ingredients in a broad range of dairy products, such as milk for cheese making, ice cream, yogurt, beverages, soups, and salad dressings. MPC powders are commercially available in protein concentrations ranging from 35% to 90% and are denominated accordingly: MPC40 contains 40 wt % protein. Likewise, MPC can also be called milk protein isolate (MPI) when the amount of protein is higher than 80 wt %.

Still further, the source of micellar casein can be (skimmed) concentrated milk. Accordingly, in one embodiment the starting cheese milk comprises one or more of skim milk, whole milk and/or cream that is supplemented with one or more of Milk Protein Isolate (MPI), milk protein concentrate (MPC) and concentrated milk.

In another specific embodiment, the starting cheese milk comprises a conventional cheese milk supplemented with micellar casein isolate (MCI), milk protein concentrate (MPC) and/or concentrated milk. Preferably, it is a cheese milk supplemented with MCI. In a specific embodiment, the source of micellar casein comprises a casein-enriched retentate obtained by milk microfiltration, which is optionally diluted with water and/or whey. For example, fresh skim milk is subjected to a microfiltration process, in much the same process used to concentrate whey protein, to produce a pure, substantially undenaturated milk protein with its native structure. The resulting material contains between 90% and 95%, preferably more than 95% by weight of micellar casein based on total protein, the rest mainly being whey protein and other non-protein nitrogen and other constituents, such as lactose and inorganic salts, in particular calcium phosphate. The casein micelles generally have a hydrodynamic radius of 40 to 400 nm, a molecular weight of 10⁶ to 10⁹ Dalton and a calcium: phosphorous weight ratio of 1.4 to 2.4.

After preparing a starting cheese milk that is enriched in micellar casein, a method according to the invention comprises adding a relatively small amount of non-micellar casein protein in order to modulate the clotting behavior of the cheese milk.

In one embodiment, the non-micellar casein is added in such amount so as to reach a final concentration of at least 0.1 wt %, preferably at least 0.15wt %, more preferably 0.2wt % or more. The upper concentration limit is not critical, but it is typically below 25 wt %, preferably up to 20 wt %, up to 18 wt %, up to 15 wt %, or up to 12 wt %. In a particularly suitable embodiment non-micellar casein is added in the range of 0.2 to 20 wt %, preferably 1 to l0wt %, more preferably 1.5 to 5wt %.

In a preferred embodiment, the non-micellar casein protein comprises casein macropeptide (CMP). CMP is cleaved from natural casein protein as a result of the action of the rennet on kappa casein, and about 90 wt % of this CMP is typically removed with the whey. CMP is a heterogeneous group of proteins. CMP contains all the genetic variations and post-translational modifications of kappa casein (Yvon et al Reprod Nutr Dev (1994) 34,527-537). As a result of this CMP may have two amino acid sequence (variants type A and B), differing degrees of phosphorylation and most significantly a range in the level, position and type of carbohydrate moieties. The predominant carbohydrate is sialic acid. Kappa casein is a rich source of the amino acid threonine with 14 to 15 threonine residues depending on the genetic variant. Casein macropeptide is variously referred to in the art as casein macropeptide, caseinomacropeptide, casein-derived peptide, casein glycopeptide and sometimes, erroneously as glycomacropeptide.

The CMP for use in a method of the invention can be obtained from various sources. Methods for obtaining CMP based on ion exchange chromatography and ultrafiltration have been used for large-scale preparation of CMP with either chymosin-treated casein, caseinates or rennet whey as a starting material.

Based on the thermostability of CMP and on the differences in molecular weight of its polymeric and monomeric forms, a method of isolating CMP from whey protein concentrate (WPC) and from liquid sweet cheese whey was developed, particularly suited to large-scale industrial production (Martin-Diana et al. J. Eur Food Res Technol (2002) 214: 282). This procedure includes acidification and heating and ultrafiltration of cheese whey to give a CMP powder with a protein content of 75 to 79 wt %. Thus, in one embodiment of the invention the non-micellar casein comprises a CMP powder.

Other non-micellar casein protein for use in the present invention comprise a caseinate, preferably 8-casein, sodium caseinate (NaCas) and/or calcium caseinate (CaCas). NaCas is generally produced from skim milk by acid precipitation and resuspension of the precipitate under alkaline conditions (NaOH). Caseinate salts, in general, are known for their ability to form aggregates at low pH. The degree of this aggregation is pH dependent (Nakagawa and others 2016). In NaCas, the casein-casein interactions are controlled by electrostatic repulsion between the components of the casein molecules. These repulsions are weaker for monovalent cations when compared to divalent cations (such as calcium), and this enables the overcoming of the hydrophobic association energy resulting in the formation of hydrated aggregates (Carr and Golding 2016). Some difficulties are present during NaCas manufacture such as the high viscosity of NaCas solution at moderate concentrations limiting the total solids of the feed for spray-drying to 20%. Likewise, coating of casein micelles with a viscous film delays the dissolution of the caseins after the addition of alkali. To overcome these difficulties, it is important to control the pH and temperature during manufacture (Sarode and others 2016). It is known that during NaCas manufacture calcium phosphate is removed from the casein micelle and the structure is damaged producing individual casein proteins.

CaCas is produced by acid precipitation of skim milk and resuspension with calcium hydroxide (Ca(OH)₂). In CaCas, almost all of the calcium is tightly bound to the strong anionic sites of the proteins, as a result of hydrophobic bonds. This causes rearrangement of the caseins by reduction of intermolecular repulsion and formation of aggregates with a predominance of charged κ-casein on the surface. Consequently, CaCas is poorly hydrated and compact (Carr and Golding 2016).

Step (iii) of a method provided herein comprises subjecting the casein-supplemented cheese milk to a coagulation process to form a gel. Coagulation is essentially the formation of a gel by destabilizing the casein micelles causing them to aggregate and form a network which partially immobilizes the water and traps the fat globules in the newly formed matrix. As is well known in the art, coagulation can be accomplished in various ways, e.g. with an acid treatment, a heat-acid treatment or using enzymes.

Lowering the pH of the milk results in casein micelle destabilization or aggregation. Acid curd is more fragile than rennet curd due to the loss of calcium. Acid coagulation can be achieved naturally with the starter culture, or artificially with the addition of gluconodeltalactone (GDL).

Chymosin, known also as rennin or rennet, is most often used for enzyme coagulation. Chymosin (EC3.4.23.4) is a proteolytic enzyme related to pepsin that synthesized by chief cells in the stomach of some animals. Chymosin proteolytically cuts kappa casein, converting it into para-kappa-casein and CMP.

Para-kappa-casein does not have the ability to stabilize the micellar structure and the calcium-insoluble caseins precipitate, forming a curd. Chymosin is a very important industrial enzyme because it is widely used in cheese making. In the past chymosin was extracted from dried calf stomachs for this purpose, but the cheese making industry has expanded beyond the supply of available calf stomachs. It turns out that many proteases are able to coagulate milk by converting casein to para-casein and alternatives to chymosin are readily available. “Rennet” is the name given to any enzymatic preparation that clots milk. The major component of rennet is chymosin but in commercial preparations of rennet other proteases, typically bovine pepsin, are found in varying concentrations.

In a preferred embodiment, step (iii) of a method of the invention comprises subjecting the casein-supplemented cheese milk to a conventional renneting procedure wherein CMP is generated during rennet hydrolysis of casein. In that manner, it is possible to produce a cheese whey that comprises CMP generated during rennet hydrolysis of casein and “recycling” this CMP-containing whey in step (ii) to obtain a casein-supplemented cheese milk. Herewith, the loss of valuable protein components is even further minimized. However, the use of CMP-containing whey which is obtained in a separate process and/or location is of course also envisaged.

In step (iv), the gel is cut into a cheese curd. Cutting the gel is an essential step in the cheese making process, as it provides more surface area for continued drainage of the whey. The curd size has a great influence on moisture retention. Smaller curds will also dry out faster and, therefore, other factors such as cooking temperature and stirring out may have to be adjusted according to curd size.

Cutting a curd may involve manual or automated cutting. Manual cutting is done with cutting harps, made by stretching stainless steel wire over a stainless steel frame. Total cutting time should typically not exceed 10 minutes, preferably less than 5 minutes, because the curd is continually changing (becoming overset) during cutting. The knives should be pulled quickly through the curd so has to cut the curd cleanly. When using mechanical knives, curd size is determined by the design of the vat and agitators, the speed of cutting (rpm) and the duration of cutting. It is important that the knives are sharp and cut the curd cleanly rather than partially mashing the curd or missing some pieces altogether. Curd should be agitated gently or not at all after cutting to prevent formation of fines.

The invention also provides the use of non-micellar casein to reduce the rate of coagulation in a cheese making process wherein a cheese milk is used that has an increased micellar casein content as compared to natural bovine milk. Herewith, application of the invention allows more time to select the optimum point to cut the coagulum, reduce the variability in curd strength during cutting and/or to maximize the yield of the cheese making process. In particular, the invention provides the use of non-micellar casein to reduce the rate of rennet gelation and/or to reduce the strength of a rennet-induced gel during renneting. As also described herein above, said non-micellar casein protein may suitably be selected from the group consisting of Casein Macro Peptide (CMP) and caseinate, preferably 8-casein, calcium caseinate and/or sodium caseinate.

### DESCRIPTION OF FIGURES

FIG. 1 shows the results of Schreiber firmness tests (Example 2)

FIG. 2 shows the results of the aggregation control tests (Example 3)

### EXPERIMENTAL SECTION

### Materials and Methods

In examples below several sources of caseins have been used. When referring to Sodium Caseinate, this was Excellion EM7 (FrieslandCampina

DMV), for Calcium Caseinate it was Excellion EM9 (FrieslandCampina DMV).

When referring to CMP (Casein Macro Peptide), three 3 different interchangeable preparations were used:
1. A commercial CMP sample
2. A sample prepared from cheese whey through following procedure:
   a. Heating cheese whey in batch for 1 hour at 95° C. to denature all whey proteins.
   b. Removing whey proteins through 300 gm sieve and centrifuge.
   c. Passing residual whey over 10 kD ceramic membrane to remove lactose and minerals.
   3. CMP concentrated in cheese whey that was obtained from cheese manufacturing trials in which the cheese milk was diluted with one of the above preparations and was passed over a 5 kD membrane at 10° C. at 3 bar.

A CMP concentration of >80% protein on dry matter was found in each of the above preparation as determined by RP-HPLC analysis.

The gel strength of the coagulum was determined using the established Schreiber test (Muthukumarappan et al. (1999) J. Dairy Sci. 82: 1068-1071). Briefly, this test involves putting the coagulum in the centre of a test plate on which concentric circles are drawn; the increase in area during gradual collapse of the coagulum is a measure for its firmness—i.e. higher numerical scores mean more surface covered and thus a less firm coagulum.

### EXAMPLE 1

### Addition of Caseinate Reduces Gel Strength of Casein-Enriched Cheese Milk

A cheese milk enriched in micellar casein was prepared by mixing 125 g of water, 280 g Skim Milk and 645 g Full Cream Milk. The mixture containing ˜2.5 wt % of micellar casein was preheated to 50° C. Each of 3 beakers was filled with 350 grams of this mixture, and 2.0 g of CaCl2 was added to each beaker.

1.0 g of Sodium Caseinate was added to beaker 2 and 1.0 g of Calcium Caseinate was added to beaker 3.

The resulting blend was cooled down to temperature of 35° C. and agitated for 10 minutes to ensure homogeneous distribution of all ingredients.

2.0 g of rennet (1:9 dilution of Kalase—Calf Rennet, CSK) was added to each beaker and agitated for another 5 minutes. The contents of each beaker was evenly distributed over 5 equally sized and shaped cups. Coagulation was allowed under controlled temperature of 35° C.

After 40, 50, 60, 70 and 80 minutes respectively, one cup was turned on a Schreiber test plate and the surface area formed by the gel was measured.

For each point in time it was observed that the gel from beakers 2 and 3, covered a larger area and thus was less firm compared to reference beaker 1.

### EXAMPLE 2

### Addition of Whey Comprising Caseinate Reduces Gel Strength of MCI-Enriched Cheese Milk

1200 g MCI (Micellar Casein Isolate—MCI80TL from FrieslandCampina DOMO factory in Lochem) and 428 g Cream (40% fat) were separately preheated to 50° C. and then mixed to a micellar casein content of ˜10%.
4 beakers were filled each with 407 grams of this mixture.

Two 2 different types of “whey” were prepared:
a. Regular cheese whey diluted with water to 2% w/w of lactose
b. Regular cheese whey diluted with water to 2% w/w of lactose to which 2% of CMP was added.

The whey preparations were heated to 50° C. Then:
To the first beaker 644 g of diluted cheese whey as prepared under a. was added.
To the second beaker 644 g of CMP-whey as prepared under b. was added.
To the third beaker 644 g of diluted cheese whey as prepared under a. was added. Also 1.0 g of sodium caseinate was added.
To the fourth beaker 644 g of diluted cheese whey as prepared under a. was added. Also 1.0 g of calcium caseinate was added.
The beakers were cooled down to a temperature of 35° C. and agitated for 10 minutes to ensure homogeneous distribution of all ingredients.
0.2% w/w of rennet (1:9 dilution of Kalase - Calf Rennet, CSK) was added to each beaker and agitated for another 5 minutes.
The contents of each beaker was equally distributed over 4 equally sized and shaped cups.
The content of all cups was coagulated under controlled temperature of 35° C.
After 40 and 60 minutes respectively one cup was turned on a Schreiber test plate and the surface area was measured.

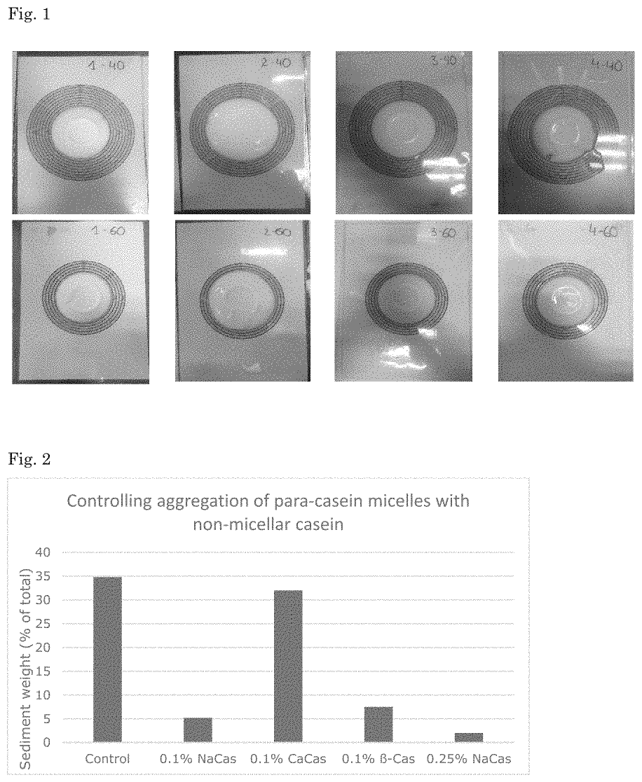

For each point in time the gel from beakers 2, 3 and 4, it was observed that the gel covered a larger area and thus was less firm compared to reference beaker 1 (see FIG. 1).

### EXAMPLE 3

### Controlling Aggregation of Para-Casein Micelles with Non-Micellar Casein

The following procedure was followed:
MCI was dissolved to 3.5% w/w protein in Milk Permeate.
To 5 test tubes was added:

Nothing—control

0.1 w% sodium caseinate

0.1 w% calcium caseinate

0.1 w% B casein

0.25 w% sodium caseinate
The content of each tube was renneted for 75 minutes at 30° C.
Next the test tubes were centrifuged 10 minutes at 2000 g.
The sediment weight was determined.

As shown in FIG. 2, it was observed that:
a) Significantly less sediment was formed in each sample compared to the control. Sodium caseinate was more effective than ß-casein, which in turn was more effective than calcium caseinate.
b) Increasing the amount of sodium caseinate further reduced the amount of sediment formed.

### EXAMPLE 4

### Effect of CaCl2 on Caseinate-Impaired Coagulation

Cheese milk was prepared from (control/with CMP/with sodium caseinate):
56.1 g water/85.6 g whey/42.3 g MCI/16.0 g cream (control cheese milk)
55.0 g water/83.9 g whey/2.8 g CMP/42.3 g MCI/16.0 g cream
55.0 g water/83.9 g whey/2.8 g sodium caseinate/42.3 g MCI/16.0 g cream

Three solutions with different concentrations of CaCl2 were added to each of the cheese milk preparations:
0% (control)
0.25% w/w of 35% CaCl2 solution
0.50% w/w of 35% CaCl2 solution

All preparations were renneted at 30° C. and gel rheology was measured in a rheometer.

It was observed that for each cheese milk, after 85 minutes:

1) With respect to CMP addition:
Addition of CMP impaired the renneting. No coagulation occurs in the absence of added CaCl₂
CaCl₂ addition partially restores rennetability but the firmness of the curd formed remained lower than the equivalent control cheese milk samples (i.e. control cheese milk sample with same CaCl₂ content).

2) With respect to sodium caseinate addition:
Sodium Caseinate addition impaired the renneting. No coagulation occurs in the absence of added CaCl₂.
CaCl₂ strongly improves rennetability: the firmness of the curd is higher than the equivalent control cheese milk samples.

### EXAMPLE 5

### Addition of CMP slows down the renneting time

A cheese milk (8 wt % casein protein, 3 wt % lactose) was obtained by blending:

| | | |
|---|---|---|
| MCI | 1728 | g |
| Cream | 684 | g |
| Whey | 561 | g |
| Lactose | 27 | g |

Further:
1 bucket of cheese milk was preheated to 35° C. and 2 buckets to 42° C.
1.5% w/w CMP was added to one of the 42° C. buckets.
2% w/w of rennet was added to all buckets (1:9 dilution of Kalase—Calf Rennet, CSK).

It was observed that the renneting time for the 35° C. bucket was 14 minutes, while the 42° C. bucket did coagulate in 6 minutes only. Addition of CMP restored the coagulation time at 42° C. to 19 minutes.

1. A method for preparing a cheese curd, comprising:
(i) providing a starting cheese milk that has an increased micellar casein content as compared to natural bovine milk;
(ii) adding non-micellar casein protein to the cheese milk to obtain a casein-supplemented cheese milk;
(iii) subjecting the casein-supplemented cheese milk to a coagulation process to form a gel; and
(iv) cutting the gel into a cheese curd.

2. The method according to claim 1, wherein the starting cheese milk has a micellar casein content of at least 2.7 wt %,

3. The method according to claim 1, wherein the starting cheese milk has a micellar casein content between 3 to 15 wt %.

4. The method according to claim 1, wherein the starting cheese milk comprises one or more of skim milk, whole milk and/or cream supplemented with micellar casein isolate (MCI), milk protein concentrate (MPC) and/or concentrated milk.

5. The method according to claim 1, wherein the starting cheese milk comprises.

6. The method according to claim 1, comprising adding the non-micellar casein protein in an amount of at least 0.1 wt %.

7. The method according to claim 1, comprising adding the non-micellar casein protein in an amount between 1 to 10 wt %.

8. The method according to claim 1, comprising subjecting the casein-supplemented cheese milk to a conventional renneting procedure to form a gel.

9. The method according to claim 1, wherein the non-micellar casein protein comprises caseinate, calcium caseinate and/or sodium caseinate.

10. The method according to claim 9, wherein the non-micellar casein protein comprises ß-casein.

11. The method according to claim 1, wherein the non-micellar casein protein comprises Casein Macro Peptide (CMP).

12. The method according to claim 11, wherein the CMP is added in the form of a cheese whey comprising CMP generated during rennet hydrolysis of casein.

13. The method according to claim 11, wherein the cheese whey comprising CMP generated during the renneting procedure of (iii) is used in (ii) to obtain a casein-supplemented cheese milk.

14. A method for increasing the yield of a cheese making process wherein a starting cheese milk is used that has an increased micellar casein content as compared to natural bovine milk, the method comprising:
(i) providing a starting cheese milk that has an increased micellar casein content as compared to natural bovine milk;
(ii) adding non-micellar casein protein to the cheese milk to obtain a casein-supplemented cheese milk;
(iii) subjecting the casein-supplemented cheese milk to a coagulation process to form a gel;
(iv) cutting the gel into a cheese curd and separating the whey from the curd; and
(v) processing the curd into a cheese.

15. The method according to claim 14, wherein the starting cheese milk has a micellar casein content of at least 2.7 wt %.

16. The method according to claim 14, wherein the starting cheese milk comprises one or more of skim milk, whole milk and/or cream supplemented with micellar casein isolate (MCI), milk protein concentrate (MPC) and/or concentrated milk.

17. The method according to claim 14, wherein the starting cheese milk comprises a conventional cheese milk supplemented with MCI, MPC and/or concentrated milk.

18. The method according to claim 14, comprising adding the non-micellar casein protein in an amount of at least 0.1 wt %.

19. The method according to claim 14, comprising subjecting the casein-supplemented cheese milk to a conventional renneting procedure to form a gel.

20. The method according to claim 14, wherein the non-micellar casein protein comprises caseinate, calcium caseinate and/or sodium caseinate.

21. The method according to claim 14, wherein the non-micellar casein protein comprises Casein Macro Peptide (CMP).

22. The method according to claim 21, wherein the CMP is added in the form of a cheese whey comprising CMP generated during rennet hydrolysis of casein.

23. The method according to claim 21, wherein the cheese whey comprising CMP generated during the renneting procedure of (iii) is used in (ii) to obtain a casein-supplemented cheese milk.
